(19) United States
(12) Patent Application Publication
(10) Pub. No.: US 2009/0206044 A1
(43) Pub. Date: Aug. 20, 2009

(54) ANTI-VORTEX DOUBLE DRAIN SYSTEM

(76) Inventor: J. Wayne Van Toever, Bristol, TN (US)

Correspondence Address: SIMPSON & SIMPSON, PLLC, 5555 MAIN STREET, WILLIAMSVILLE, NY, 14221-5406, US

(21) Appl. No.: 12/370,068

(22) Filed: Feb. 12, 2009

Related U.S. Application Data
(60) Provisional application No. 61/065,700, filed on Feb. 14, 2008.

(51) Int. Cl. B01D 21/24; A01K 63/04

(52) U.S. Cl. 210/788; 210/167.21; 210/167.23; 210/117

(57) ABSTRACT

Enhancements to the Double Drain technology used for separation of settle-able solid wastes previously developed. Anti-vortex fins are added to the central clarified effluent water manifold to minimize re-suspension of settled solids. A further aspect includes the addition of a slotted horizontal cover plate to a solid waste collection sump below the tank floor. These additions significantly increase the effectiveness of the Double Drain system for separation of settle-able solid waste from fish culture water. The enhanced Double Drain Tank design with the anti-vortex feature could also be used in non-fish culture applications to enhance the separation of settle-able solids from any liquid waste water flow.

### CROSS-REFERENCE TO RELATED APPLICATIONS

This application claims the benefit under 35 U.S.C. §119(e) of U.S. Provisional Application No. 61/065,700, filed on Feb. 14, 2008, which application is incorporated herein by reference.

### BACKGROUND OF THE INVENTION

In previous patents, such as U.S. Pat. Nos. 5,055,186 and 5,593,574 to Van Toever, which are incorporated herein by reference, a Double Drain system is described, which takes advantage of the natural tendency for the spinning circulation flow in circular fish tanks to move and concentrate settle-able solids, consisting of excess uneaten fish feed and fish feces, to the center of the tank floor. This phenomenon is commonly referred to as the “tea cup effect.”

The tanks are operated to achieve this effect by injecting the inlet fish culture water, tangentially into the tank to slowly rotate the water column. The fish swim into the current created and spread out uniformly through the water column. The constant gentle swimming provides exercise for the fish and the rotating flow provides relatively uniform water quality for each fish. This primary rotating flow induces a secondary flow of water in a radial direction across the tank floor toward the center of the tank. With sufficient spin, this radial bottom flow will transport waste particles that settle to the tank floor to the center of the tank.

Before the Double Drain system was developed, the combined fish culture water and wastes were continually flushed from the tanks through a single screened, central bottom drain or central vertical screened pipe. The Double Drain design provides two strategically placed exits from the fish tanks, one for clarified waste water or effluent and one for the settled solids that concentrate at the center of the tank floor, the Double Drain innovation provides a very simple, inexpensive and effective mechanism for separation of settle-able solid waste from the fish culture water.

Rapid removal of the intact solid wastes reduces the cost and complexity of subsequently separating them from a single effluent stream and minimizes mechanical breakdown of the particles and secondary leaching of dissolved wastes from the solid waste particles. This is a very important first step in filtering fish culture water to enable re-use of the fish culture water and to minimize the environmental impact of fish culture operations wastewater discharge.

The previous designs included two basic versions. One is the “lateral” flow design, which is sometimes referred to as the “side box” design. Clarified waste water exits laterally through the tank sidewall through a screened pipe or external screened side box and concentrated solid wastes exit at the center of the tank floor. The second configuration is the “axial” flow design. Clarified waste water exits through a pipe manifold located vertically at the center axis of the tank through slots in the pipe located at the mid-upper water column level of the tank and concentrated solid wastes exit from a concentric opening at the base of the clarified water manifold at the center of the tank floor.

Experience with operating circular fish culture tanks together with laboratory studies of circular Double Drain tanks have demonstrated that the axial flow design (clarified fish culture water exits at the center of the tank) provides a stronger “tea cup effect” than the lateral flow design. (See Veerapen, J. P., Brian J. Lowry and Michel F. Couturier; Solids Separation in Double-Drain Fish Tanks; Recirculation Aquaculture Research Group, Department of Chemical Engineering, University of New Brunswick, Canada.) This makes intuitive sense as the bulk of the flow with the lateral design is injected into the tank at the outer wall and exits at the outer wall essentially short-circuiting the flow. With the axial flow design in contrast, water moves more uniformly through the tank from the periphery where it is injected to the center where it exits. Despite this deficiency, the lateral flow design is popular especially for larger fish tanks such as those greater than 3 meters in diameter.

Double Drain Systems have usually been operated by splitting the effluent flow into two continuous streams. The larger flow is the clarified water flow, which normally exits the tank and undergoes several other filtration processes before being returned to the tank. The so-called “under-drain” split, which carries the solids out of the tank at the center of the floor, is controlled so that the flow is just sufficient to extract the solids from the tank. Since the under-drain fraction is generally directed to waste and not re-circulated to the fish tank, it is desirable to minimize this flow.

Since all of the clarified water flow exits through the tank sidewall with the lateral flow design, and as noted, the “tea cup effect” is weaker with this configuration, to compensate for this, the under-drain flow split must be increased to enhance the “tea cup effect.” With increasing tank diameter, more water must be diverted out the under-drain to move solids across the tank floor to the center or else they will settle and accumulate on the tank floor. Unfortunately this means that increased culture water is lost along with the solid wastes. The more dilute under-drain flow therefore usually has to be further treated to concentrate the solids content and recover some of the culture water before flushing the concentrated solids to waste. The added cost for the extra filtration technology can be significant, especially with larger fish culture tanks which have large under-drain flows.

It has been found that the axial flow design (clarified water exiting at the center of the tank) has a stronger “tea cup effect” and the solids, which settle to the tank bottom move to the center even if the under-drain flow is reduced to zero. Since the solids can be removed as a concentrate with little or no under-drain flow, the upper clarified flow is larger and a greater percentage of the fish culture water can be re-circulated with less secondary filtration required to do so.

Another phenomenon, which commonly occurs when operating circular fish culture tanks with higher water exchange rates (generally greater than 2 exchanges per hour) is the formation of a vortex at the center of the tank. A vortex in a fish tank is the equivalent of a tornado in the atmosphere. As the vortex increases in definition and intensity, solids which have settled and migrated to the center floor of the tank are re-suspended into the water column just as a tornado lifts objects off the ground. The solids are broken down into smaller particles and are re-distributed though-out the tank water column, significantly deteriorating the water quality for the fish. A small, low energy vortex will only have sufficient velocity to re-suspend the smallest particles but as the spin on the tank increases and the vortex intensifies, larger settled solids and eventually all the settled solids will be lifted off the bottom and re-suspended in the water column, therefore negating the “tea cup effect” completely.

As noted, the axial flow design has the strongest “tea cup effect” but because all of the clarified water exits at the center, it is also more prone to the establishment of vortices.

An exemplary embodiment of the previous axial flow design is shown in FIG. 1 which schematically illustrates fish tank 10 on supports 12 with cylindrical side 14 and floor 16. Water level in the tank is illustrated by dotted line 18. The tank 10 incorporates a single, larger slotted pipe 20 in the center of tank 10 with two sets of outlet slots, one upper set of slots 22 and a second set of slots 24 adjacent tank floor 16. Upper set of slots 22 are for the clarified water effluent which will be processed further (not shown or described herein) before it is returned to the tank. A secondary, smaller vertical pipe 28 is located concentrically in the larger slotted pipe 20. Opening 30 of smaller pipe 28 is adjacent the upper set of slots 22 in outer pipe 20 and it serves as the clarified water effluent outlet for tank 10, which water is processed further as noted above. The second set of slots 24 located at the base of larger pipe 20 provides the outlet for solids transported to this point by the “tea cup effect.” All the slots 24 are sized to retain the fish in the tank, but they allow water and solids to exit. A horizontal plate 34 located inside the larger slotted pipe 20 divides the pipe 20 into an upper clarified water chamber 36 and a lower solids chamber 38. Plate 30 prevents flow between lower solids chamber 38 and upper clarified water chamber 36 so that solids are not drawn into the clarified water flow shown by arrow 40.

Lower solids cylindrical chamber 44 is molded or otherwise secured at 46 onto tank floor 16 which forms a socket to install the larger slotted pipe 20 within the chamber 44. Small concentric space 46 between the lower end of smaller pipe 28 and base of larger pipe 20 within chamber 44 allows for the addition of horizontal solids outlet pipe 50 exiting the side of chamber 44. Solids or particulates are drawn through the lower bottom set of slots 24 by the under-drain flow and exit chamber 44 out pipe 50 which has flow control valve 52. For small fish culture tanks with low densities of fish, there may be sufficient volume available in the small concentric space 46 to store the small amounts of solids waste produced so that no continuous under-drain flow is required out pipe 50. Solids can be stored in the concentrated space 46 and periodically flushed to waste by opening valve 52 on the end of the pipe 50. With greater fish densities and waste generation a small, more continuous under-drain flow out pipe 50 is required to continually extract solids or wastes to external storage. Clarified water effluent within smaller pipe 28 passes out conduit 60 to external level control stand pipe 62 as is known in the art. As is evident from FIG. 1, the clarified water effluent in the stand pipe passes upwards between outer pipe 64 and inner pipe 66 and then into inner pipe 66 through upper opening 68, from which the clarified water effluent exits at 70 to be further processed (not shown) as is known in the art. By connecting the stand pipe 62 with conduit 60 by a rotatable coupling 72, the stand pipe 62 can rotate or pivot about coupling 70 and control the level 18 of water in tank 10, as is known in the art.

### SUMMARY OF THE INVENTION

The invention in one broad aspect pertains to apparatus for use in association with removing clarified waste water from a fish tank comprising, at least one vertical fin structure adapted to extend in an axial direction along a periphery of a clarified waste water manifold centrally located in the fish tank.

Another broad aspect pertains to a fish tank system wherein water is injected into the fish tank having a wall and floor to cause spinning circulation flow to water in the tank, and wherein the flow causes settable-solids in the tank to move to the center of the tank. A clarified water effluent outlet pipe concentric with the tank has openings adjacent an upper end through which clarified waste exits the tank for further processing. A sump below the tank floor, adjacent the center of the tank, has a substantially horizontal cover plate with openings sized to permit the settable-solids to gravitate into the sump but prevent fish from passing through the openings.

Another aspect of the invention pertains to a method of reducing suspension of settable-solid particulates in a fish tank system having a wall and floor wherein water injected into a fish tank causes a spinning circulation flow in the water in the tank and wherein the settable-solid particulates in the tank are caused to move to the center of the tank, the method comprising:
a. providing a clarified water effluent outlet pipe concentric with the tank having openings adjacent an upper end through which clarified water effluent exits for further processing;
b. providing a sump adjacent to the bottom of the tank with a cover plate substantially in line with the tank floor and through which the settable-solids particulate can gravitate into the sump; and,
c. providing a fin assembly in association with the clarified water effluent pipe, the fin assembly comprising at least one fin extending along and outwardly from the clarified water effluent pipe.

More particularly, with a new inventive feature herein, the larger extended slotted pipe 20 has been eliminated and an anti-vortex assembly is provided to reduce vortex agitation of solids adjacent the clarified water effluent pipe. Preferably this anti-vortex can take the form of at least one fin attached directly to the clarified water effluent pipe or manifold which as noted above in the prior art embodiment, was concentrically inserted in a larger slotted pipe. The clarified water effluent pipe or manifold extends to the top of the fish tank and one set of upper slots provides for the clarified water effluent outlet. Although a preferred anti-vortex assembly is shown in the detailed embodiment which follows, any anti-vortex assembly of baffles or fins associated with the tank or clarified water effluent outlet is contemplated by this invention.

A preferred embodiment of the anti-vortex assembly comprises at least one and preferably two anti-vortex fins associated with and extending the length of the clarified water effluent pipe, the fins or baffles effective in providing a quiet collection zone adjacent the fins at the junction of the clarified water pipe or manifold with the tank floor.

Another preferred aspect of the invention is that a larger cylindrical sump chamber molded onto the tank bottom to provide increased solids storage capacity, generally large enough to store one day's solid waste production. A slotted cover plate allows solid waste to gravitate into the sump chamber. Still further, the tangential alignment of a sump outlet pipe or manifold with the periphery of the sump chamber enhances the flushing of the chamber when the under-drain is activated through opening of the valve on such pipe or manifold.

Another broad aspect pertains to an enhanced Double Drain Tank design with an anti-vortex feature of the invention used for enhancing separation of settle-able solids from any liquid waste water flow. An aspect of the design including an apparatus for use in association with removing clarified waste water from a holding container having at least one vertical fin structure adapted to extend in an axial direction along a periphery of a clarified waste water manifold centrally located in said container. An even further aspect of the design including an apparatus for use in enhancing separation of settle-able solids from a liquid waste water flow having at least one vertical fin structure adapted to extend in an axial direction along a periphery of a clarified waste water manifold centrally located in a holding tank or container.

### BRIEF DESCRIPTION OF THE DRAWINGS

FIG. 1 is a schematic perspective view of a Prior Art Axial Flow Double Drain System;

FIG. 2 is a schematic side view of an embodiment of the invention with anti-vortex fins and slotted sump cover plate;

FIG. 3 is a schematic perspective view of the embodiment of FIG. 2, the stand pipe being omitted for clarity;

FIG. 4 is a top view of a slotted storage sump cover plate with the anti-vortex fins;

FIG. 5 is a schematic side view of a second embodiment of the invention wherein the waste collection sump outlet is offset and aligned tangentially with the sump wall; and,

FIG. 6 is a schematic perspective view of the second embodiment of FIG. 5, the stand pipe being omitted for clarity.

### DESCRIPTION OF THE PREFERRED EMBODIMENT

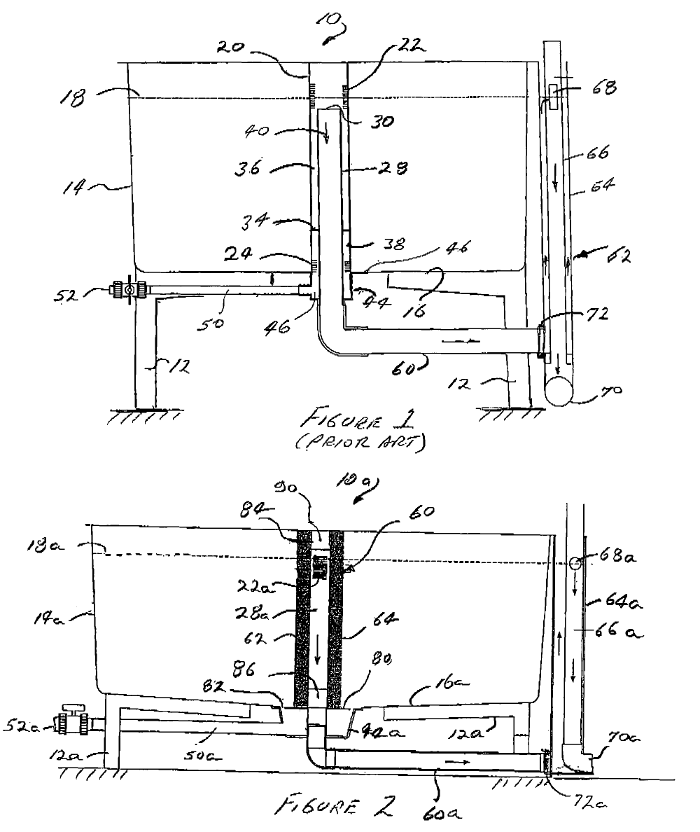

With respect to FIGS. 2-4, structural features being common relative to those in FIG. 1 are noted with the letter “a”.

To take advantage of the stronger “tea cup effect” of the axial flow design in higher flow configurations, consideration was given to attempting to lessen the formation of vortices. The most effective preferred configuration has been the addition of an anti-vortex fin assembly 60, preferably with two relatively narrow vertical fins 62, 64 along the sides of the central clarified water manifold 28a extending the entire depth of the water manifold as seen in FIGS. 2-4. This new anti-vortex axial flow configuration allows for a strong “tea cup effect” while minimizing the re-suspension of settled solids. It creates a “quiet zone” at the base of the vertical clarified water manifold 28a adjacent tank floor 16, where solids can be easily removed from the fish tank.

A second aspect of the invention allows passive removal of settled solid particles into an enlarged storage chamber 44a located below the center of the tank from which concentrated solids can be periodically flushed in small concentrated batches with no significant water loss. No continuous under-drain split flow is required with this design.

As previously described, the prior art design used a second set of slots 24 at the base of the larger double slotted pipe 20 for removal of solids. The solids in that structure moved horizontally through the slots 24 into the small concentric collection area. The under-drain flow transported the settled particles through the slots into the chamber 44 and out the horizontal waste pipe 50.

With the design as illustrated in FIGS. 2-4, there is larger storage sump 44a and a slotted horizontal sump cover plate 80 provided to prevent fish from entering the sump 44a. Solids are drawn onto the surface of the plate 80 by the “tea cup effect” and simply fall by gravity through slots 82 into the storage sump 44a below. No under-drain flow is required to move the solids through the horizontal openings or slots 82 so the solids can accumulate in a concentrated form in chamber 44a and are simply batch dumped through pipe 50a to a larger centralized waste storage area (not shown) once or twice daily with an insignificant amount of associated culture water exiting with the solids. No further treatment is required to extract re-usable culture water from the solids.

The anti-vortex fin assembly 60 is preferably fabricated by attaching the fins 62, 64, to upper and lower sleeves 86, 88, which slide down over the waste water effluent outlet manifold 28a. The sump cover plate 80 is preferably connected to the base sleeve 86 of the anti-vortex fin assembly 60. A set screw 90 is located in the top sleeve 84 which is used to attach the anti-vortex fin assembly 60 to the slotted clarified water outlet manifold 28a. This allows removal of the assembly of fins 62, 64, and plate 80 as a unit for cleaning or changing the slot sizes of plate 80 to accommodate different fish sizes. The cover plate 80 can be detachably connected to the fin assembly.

Although the anti-vortex fin assembly 60 preferably has two diagonally opposite fins 62, 64, it will be appreciated that one fin would still be effective and more than two fins are possible. Further, the sump plate 80 need not be attached or secured to the anti-vortex fin assembly 60, but could be separate and removed and replaced by other means separately over the manifold or pipe 28a.

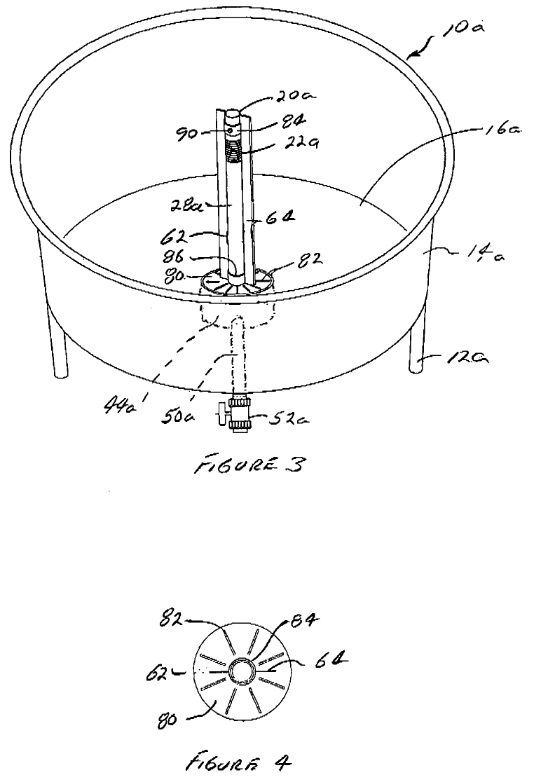

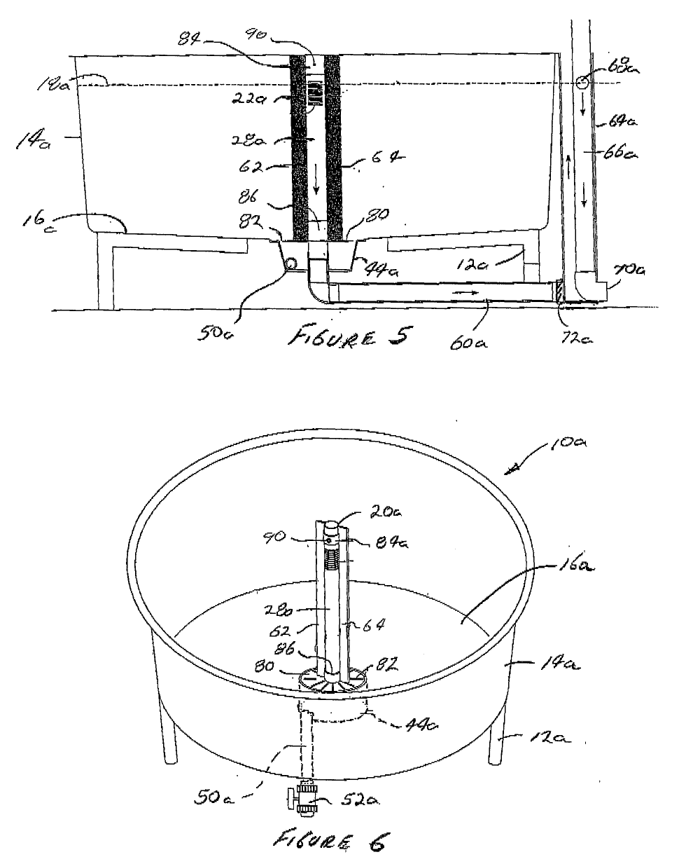

FIGS. 5 and 6 illustrate a modification to the tank 10a utilizing the anti-vortex fin assembly 60 and sump cover plate 80. Features which are similar to those of FIGS. 2 and 3 are labeled with “a”. The major difference between the first inventive embodiment of FIGS. 2 to 4 and the second modified embodiment of FIGS. 5 and 6 is in the location of the solid waste collection sump outlet 50a. It is aligned tangentially to the side wall 90 of the chamber 44a rather than on the sump side wall in line with the center of sump 44a. With the tangential design when the waste valve 52 is opened to purge the waste stored in chamber 44a, the waste and water are caused to swirl around the inside of sump 44a so the solids are flushed quickly from sump 44a and do not hang up on the walls 90 of the sump 44a.

Although the sump cover plate 80 is shown with slots to allow the settled particulate to fall by gravity into chamber 44a, circular holes or openings or other shaped openings are contemplated as long as the openings are large enough to allow all particles through, but small enough to prevent fish passing through. Accordingly, the changing of the sump cover plate 80 to one having varying sized openings may be appropriate depending on the size of the fish in the tank.

Although FIGS. 2 and 5 illustrate an external water level control stand pipe, it is technically not necessary with the new system to control the water level in the tank. The slots 22 in the clarified water manifold 28a are placed near the water column surface 18 and therefore the water level 18 is now determined by these slots. Generally the water covers several of the lower slots 22 and the actual level depends on the flow of water entering the tank in relation to the size of the slots and flow out manifold 28a. With smaller tanks up to about 1.5m diameter, the manifold 28a may be reached from outside the tank and lifted vertically to drain the tank. Alternately the tank may be drained out though the solid waste sump 44a which usually is required for harvesting fish.

Although a preferred embodiment of the invention is set forth above, with respect to the baffle design, different baffle designs and sizes of baffles are contemplated in association with the tank or the clarified water effluent pipe or manifold. Applicant found that with no baffles of any design and with sump cover plate 80 in place and with water in the tank caused to slowly rotate by treated water introduced into the tank, particles settled to the floor of the tank, moved to the center and although larger particles gravitated through the openings 82 in the cover plate 80, smaller particles were re-suspended and drawn vertically upwards and exited out the slots 22 in the manifold or pipe 28a.

With horizontal baffles at the water surface extending from the outer tank wall 14 to the center water manifold 28a, trials were made with baffles across half of the tank, and also across the full tank diameter. These surface baffles slowed the spin at the tank water surface and prevented formation of an obvious vortex in the upper region of manifold 28a but at the tank floor 16 vortexes continued to spin rapidly and fine particulates were still re-suspended. Nevertheless, use of the horizontal baffles did decrease the vortex overall in comparison to the trials with no baffles and more of the particles in the mid-size range fell into the sump rather than being re-suspended so there was an improvement in the quantity of wastes removed.

In another embodiment, the addition of vertical baffles on the inner walls 14 of the fish tank 10 generally slowed the spin of the water column somewhat but were not effective in reducing the spin over the sump 80 sufficiently to prevent re-suspension of fine particulates. However, the baffles did improve and increase the overall quantity of waste removed.

Various numbers, lengths and widths of vertical baffles were added to the walls of the clarified water manifold 28a and the impact on solids re-suspension was observed. Baffles added to the sides of the manifold 28a only along the upper portion of the pipe affected solids removal in a similar manner to the horizontal surface baffles noted above. The spin in the upper water column was decreased but the spin in the lower water column continued to be excessive and the finer particulates were re-suspended. However, again, solids removal was superior to the trials without any baffles.

Vertical baffles were then added to the sides of only the bottom half of the clarified water manifold 28a. A visible vortex was still created at the water surface 18 but the spin of the water column at the bottom was reduced. It was observed that a quiet zone was created on the downstream side of the baffles while the water column beyond the upper edges of these baffles continued to spin relatively quickly and some of the smaller particulates continued to be re-suspended although less than in the trials without baffles.

As illustrated in the preferred embodiment, vertical baffles 62, 64 were added along the entire vertical height of the sides of the clarified water manifold, 28a. Extending the baffles and adding the upper attachment collar 84 above the water level 18, provided easier to access the set screw 90 for installation and removal of the anti-vortex fin assembly 60. Further, this most preferred design was the most effective in preventing vortex creation and excessive water column spin velocity throughout the water column adjacent the manifold 28a and had the desired effect of increasing removal efficiency of the smaller particulates. This design is effective in creating a “quiet” zone, downstream of the baffles, especially over the sump cover plate which allows even the smallest settled particle sizes to fall through the slots into the storage sump without being re-suspended. In a tank wherein the clarified water effluent was about 2 inches in diameter the baffles 62, 64 were each about 2 inches in width whereas the cover plate 80 was about 8 inches in diameter. A width of each baffle is about 25% to 33% of the diameter of the cover plate 80 is effective. The baffles need not extend as far as the peripheral edge of the cover plate to be effective.

Accordingly, Applicant's invention encompasses those embodiments not specifically described as preferred but within the scope of the invention as claimed.

What is claimed is:

1. Apparatus for use in association with removing clarified waste water from a fish tank comprising at least one vertical fin structure adapted to extend in an axial direction along a periphery of a clarified waste water manifold centrally located in said fish tank.

2. The apparatus according to claim 1 further comprising a solid waste slotted sump cover for adjacent association with a lower end of the clarified waste water manifold, said slotted cover adapted to cover a solid waste collection sump attached to a bottom of the fish tank.

3. The apparatus according to claim 1 wherein said fin structure comprises means for detachably mounting said structure to said clarified waste water manifold.

4. The apparatus according to claim 2 wherein said slotted sump cover is connected to the lower end of said fin structure which extends upwardly from the sump cover.

5. The apparatus according to claim 3 wherein the fin structure includes upper and lower collars adapted to slidingly engage said clarified waste water manifold and said at least one fin structure is connected to said collars.

6. The apparatus according to claim 5 wherein there are two diametrically opposed fin structures attached to said collars, and said sump cover plate is attached to said lower collar and removable from the tank with said fin structure.

7. In a fish tank system wherein water is injected into the fish tank having a wall and floor to cause spinning circulation flow to water in the tank, and wherein said flow causes settable-solids in the tank to move to the center of the tank, a clarified water effluent outlet pipe concentric with the tank having openings adjacent an upper end through which clarified waste exits the tank for further processing, a sump below said tank floor, adjacent the center of the tank, said sump having a substantially horizontal cover plate with openings sized to permit the settable-solids to gravitate into the sump but prevent fish from passing through said openings.

8. The fish tank system according to claim 7 wherein the sump has a periphery which is concentric about the clarified water outlet pipe which passes through a bottom of the sump.

9. The fish tank system according to claim 8 further including a valve controlled outlet pipe from the sump permitting periodic removal of the settable-solids from the sump.

10. The fish tank system according to claim 9 wherein the valve controlled outlet pipe is connected to said sump tangentially to the periphery of said sump adjacent the bottom of the sump.

11. The fish tank system of claim 7 further including at least one anti-vortex baffle associated with said tank to reduce vortex motions within the tank which cause small particulates of said settable-solids to be re-suspended in the water in the tank.

12. The fish tank system of claim 11 wherein the at least one baffle is associated with the tank wall.

13. The fish tank system of claim 7 wherein the at least one baffle is associated with an upper section of the clarified water effluent pipe.

14. The fish tank system of claim 11 wherein the at least one baffle is associated with a lower section of the clarified water effluent pipe.

15. The fish tank system of claim 11 wherein the at least one baffle is associated with the clarified water effluent pipe and extends at least the height of the water within the tank.

16. The fish tank system of claim 15 wherein there are two diametrically opposed baffles extending from a periphery of the clarified water outlet pipe.

17. The fish tank system of claim 15 further comprising a baffle fin assembly including said at least one baffle, said fin assembly comprising at least one collar to which said at least one baffle is attached, said at least one collar being adapted to removably slide over said clarified water effluent pipe.

18. The fish tank system of claim 17 wherein there are two collars, an upper collar and a lower collar and ends of said at least one baffle are connected to said respective collars.

19. The fish tank system of claim 18 wherein the sump cover plate is connected to the lower collar and is removable from the tank as part of the baffle fin assembly.

20. The fish tank system of claim 19 further including means for detachably securing said baffle fin assembly to said clarified water effluent pipe.

21. A method of reducing suspension of settable-solid particulates in a fish tank system having a wall and floor wherein water injected into a fish tank causes a spinning circulation flow in the water in the tank and wherein the settable-solid particulates in the tank are caused to move to the center of the tank, said method comprising:
a. providing a clarified water effluent outlet pipe concentric with the tank having openings adjacent an upper end through which clarified water effluent exits for further processing;
b. providing a sump adjacent to the bottom of the tank with a cover plate substantially in line with said tank floor and through which the settable-solids particulate can gravitate into the sump; and,
c. providing a fin assembly in association with the clarified water effluent pipe, the fin assembly comprising at least one fin extending along and outwardly from the clarified water effluent pipe.

22. The method of claim 21 wherein the fin assembly includes two diametrically opposed fins which are detachably associated with and extend along substantially a full length of the clarified water outlet pipe.

23. The method of claim 21 wherein the sump cover plate is connected with the fin assembly and can be removed with the fin assembly from association with the clarified water effluent pipe.

24. Apparatus for use in association with removing clarified waste water from a holding container comprising at least one vertical fin structure adapted to extend in an axial direction along a periphery of a clarified waste water manifold centrally located in said container.

25. Apparatus for use in enhancing separation of settle-able solids from a liquid waste water flow comprising at least one vertical fin structure adapted to extend in an axial direction along a periphery of a clarified waste water manifold centrally located in a holding tank or container.
